(19) United States
(12) Patent Application Publication
(10) Pub. No.: US 2026/0243453 A1
(43) Pub. Date: Aug. 20, 2026

(54) MISTING FAN

(71) Applicant: SharkNinja Operating LLC, Needham, MA (US)

(72) Inventors: Renwei LIU, Waltham, MA (US); Scott J. STEWART, Needham, MA (US)

(21) Appl. No.: 19/054,160

(22) Filed: Feb. 14, 2025

(51) Int. Cl. F24F 6/14; F04D 19/00; F04D 29/70; F24F 6/00

(52) U.S. Cl. CPC F24F 6/14; F04D 19/002; F04D 29/705; F24F 2006/008; F24F 2006/146

(57) ABSTRACT

The present disclosure includes a misting fan including a head assembly having a fan and a motor coupled to the fan, the head assembly including an articulation mechanism and a plurality of legs coupled to the articulation mechanism. In some embodiments, the misting fan includes a base assembly detachably coupled to the head assembly having a base and a support including a housing and an elongate receiving portion arranged within the housing at the second end of the support, configured to receive the plurality of legs to detachably couple the head assembly to the base assembly. In some embodiments, the misting fan includes a misting system having a supply tank, a pump, and a nozzle configured to atomize a liquid stored in the supply.

### FIELD

The present disclosure relates a motorized fan. In particular, a motorized misting fan.

### BACKGROUND

Motorized fans can generate air flow within an environment in which the motorized fan is located. Motorized fans can include a fan with fan blades that is driven by a motor coupled to a power supply. A motorized fan can include electrical components configured to control operation of the motor such that the fan can generate the air flow at different speeds. The motorized fan can also include positioning components configured to position the motorized fan and direct the generated air flow as desired within the surrounding environment.

### SUMMARY

In general, the present disclosure concerns a misting fan including a fan device and a supply tank. In some embodiments, the fan device includes a head assembly including a fan and a motor coupled to the fan. In some embodiments, the head assembly includes an articulation mechanism and a plurality of legs coupled to the articulation mechanism. In some embodiments, the misting fan includes a base assembly detachably coupled to the head assembly. In some embodiments, the base assembly includes a base and a support having a first end coupled to the base and a second end opposite the first end. In some embodiments, the support includes a housing and an elongate receiving portion arranged within the housing at the second end of the support. In some embodiments, the receiving portion is configured to receive the plurality of legs to detachably couple the head assembly to the base assembly. In some embodiments, the misting fan includes a misting system including a supply tank, a pump, and a nozzle configured to atomize a liquid stored in the supply tank and to inject the atomized liquid into the air flow generated by the fan.

In some embodiments, the nozzle is disposed within an outer perimeter of the head assembly. In some embodiments, the head assembly comprises a housing, and the nozzle is disposed in a recessed portion of the housing. In some embodiments, the misting system includes a first and second nozzle spaced by about a diameter of the head assembly. In some embodiments, the misting fan includes a grill forming a forward portion of the head assembly, and a hub disposed at a central portion of the grill. In some embodiments, the nozzle is disposed on the hub.

In some embodiments, the nozzle is disposed at an angle relative to a plane coplanar with a front of the head assembly. In some embodiments, the nozzle is disposed at angle between 15 and 75 degrees from a plane coplanar with a front of the head assembly. In some embodiments, the head assembly further includes a detachable misting unit.

In some embodiments, the pump is disposed within the head assembly. In some embodiments, the supply tank is coupled to the base.

In some embodiments, a bottom surface of the supply tank forms a port configured to receive a boss protruding from the base of the misting fan. In some embodiments, the supply tank is coupled to the support. In some embodiments, a rear surface of the supply tank forms a receiving portion configured to receive a latch on the support. In some embodiments, the supply tank includes a socket disposed in a rear surface of the supply tank, and configured to couple to a latch disposed on the fan support.

In some embodiments, the misting fan includes a pump disposed within the head assembly and fluidly coupled to the liquid supply tank and the nozzle by a hose. In some embodiments, the supply tank is configured to draw liquid from the supply tank to the nozzle disposed on the head assembly. In some embodiments, the supply tank includes a port configured to receive a boss protruding upward from the base assembly. In some embodiments, a rear surface of the supply tank forms a receiving portion configured to receive at least a portion of the support. In some embodiments, the supply tank includes a socket disposed in a rear surface of the supply tank, and configured to couple to a latch disposed on the support. In some embodiments, the latch includes an internal aperture configured to receive a pin disposed in the latch. In some embodiments, the supply tank includes a supply tank port configured to attach to a first end of a hose, and the head assembly includes a head assembly port configured to attach to a second end of the hose.

In some embodiments, a ratio of a bounded volume of the misting fan to a bounded volume of the fan device is less than 1.5. In some embodiments, a ratio of the bounded volume of the misting fan to the bounded volume of the fan device is about 1.

In some embodiments, the base assembly is detachably coupled to the head assembly. In some embodiments, the head assembly includes an articulation mechanism and a plurality of legs coupled to the articulation mechanism. In some embodiments, the support includes a housing and an elongate receiving portion arranged within the housing at and end of the support. In some embodiments, the receiving portion is configured to receive the plurality of legs to detachably couple the head assembly to the base assembly.

In some embodiments, the receiving portion can include a pair of opposing surfaces forming a guide path there between extending from the first end toward a notch at a second end of the receiving portion. In some embodiments, a first surface of the pair of opposing surfaces can be oriented in a first rotational direction configured to cause the head assembly to rotate in the first rotational direction when the head assembly is coupled to the base assembly and a second surface of the pair of opposing surfaces can be oriented in a second rotational direction, opposite the first rotational direction. The second surface can be configured to cause the head assembly to rotate in the second direction when the head assembly is coupled to the base assembly.

In some embodiments, at the least one leg can include a protrusion thereon configured to translate along at least one surface of the pair of opposing surfaces in the guide path causing the protrusion to be received within the notch. In some embodiments, the at least one leg can further include an attachment mechanism configured to be received within an opening of the housing when the head assembly is coupled to the base assembly.

In some embodiments, the plurality of legs can include 3, 4, or 5 legs. In some embodiments, the articulation mechanism can include a plurality of gears configured to cause the plurality of legs to actuate in unison from a stored position to an extended position responsive to actuating at least one leg of the plurality of legs in the stored position.

In some embodiments, the head assembly is supported by the plurality of legs and the supply tank is connected to the head assembly by tubing configured to transport water from the supply tank to the head assembly. In some embodiments, the supply tank is configured to be disposed on a common surface with the plurality of legs, such as a desk, table, or floor. In some embodiments, the supply tank is configured to be disposed above or below the plurality of legs.

In some embodiments, the head assembly can include at least one of a rechargeable battery and a first DC power supply and the base assembly includes a second DC power supply. In some embodiments, the second DC power supply is configured to provide power to the head assembly when the head assembly is coupled to the base assembly.

### BRIEF DESCRIPTION OF THE DRAWINGS/FIGURES

FIG. 1 is an isometric view of a misting fan according to an embodiment;

FIG. 2 is a rear isometric view of the misting fan of FIG. 1;

FIG. 3 is an isometric view of a misting fan according to an embodiment;

FIG. 4 is an isometric view of a supply tank according to an embodiment;

FIG. 5 is a top view of the supply tank of FIG. 4;

FIG. 6 is a side exploded assembly view of a misting fan according to an embodiment;

FIG. 7 is an isometric view of a portion of a misting fan according to an embodiment;

FIG. 8 is an isometric view of a portion of a misting fan according to an embodiment;

FIG. 9A is an isometric view of a portion of a misting fan according to an embodiment;

FIG. 9B is an isometric view of a portion of a misting fan according to an embodiment;

FIG. 10 is a side view of a portion of a misting fan according to an embodiment;

FIG. 11 is an isometric view of a supply tank according to an embodiment;

FIG. 12 is a top view of a misting fan according to an embodiment;

FIG. 13 is a sectional view of a portion of a misting fan according to an embodiment;

FIG. 14 is an isometric view of a misting fan according to an embodiment;

FIG. 15 is a rear isometric view of the misting fan of FIG. 14;

FIG. 16 is a bottom isometric view of the misting fan of FIG. 14;

FIG. 17 is a sectional view of a portion of a misting fan according to an embodiment;

FIG. 18 is an exploded assembly view of a misting fan according to an embodiment;

FIG. 19A is sectional view of a portion of a misting fan according to an embodiment;

FIG. 19B is a sectional view of a portion of a misting fan according to an embodiment;

FIG. 20 is a sectional view of a portion of a misting fan according to an embodiment;

FIG. 21A is an isometric view of a portion of a misting fan according to an embodiment;

FIG. 21B is a sectional view of a portion of a misting fan according to an embodiment;

FIG. 22 is a rear isometric view of a misting fan according to an embodiment; and

FIG. 23 is an exploded isometric view of a power system according to an embodiment.

### DETAILED DESCRIPTION

Embodiments of the present disclosure are described in detail with reference to embodiments thereof as illustrated in the accompanying drawings. References to “one embodiment,” “an embodiment,” “some embodiments,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Spatially relative terms, such as “beneath,” “below,” “lower,” “above,” “on,” “upper,” “opposite” and the like, may be used herein for ease of description to describe one element or feature's relationship to another element(s) or feature(s) as illustrated in the figures. The spatially relative terms are intended to encompass different orientations of the device in use or in operation in addition to the orientation depicted in the figures. The apparatus may be otherwise oriented (e.g., rotated 90 degrees or at other orientations) and the spatially relative descriptors used herein may likewise be interpreted accordingly.

The term “about” or “substantially” as used herein indicates the value of a given quantity that can vary based on a particular technology. Based on the particular technology, the term “about” or “substantially” can indicate a value of a given quantity that varies within, for example, 1-15% of the value (e.g., ±1%, ±2%, ±5%, ±10%, or ±15% of the value).

The following examples are illustrative, but not limiting, of the present embodiments. Other suitable modifications and adaptations of the variety of conditions and parameters normally encountered in the field, and which would be apparent to those skilled in the art, are within the spirit and scope of the disclosure.

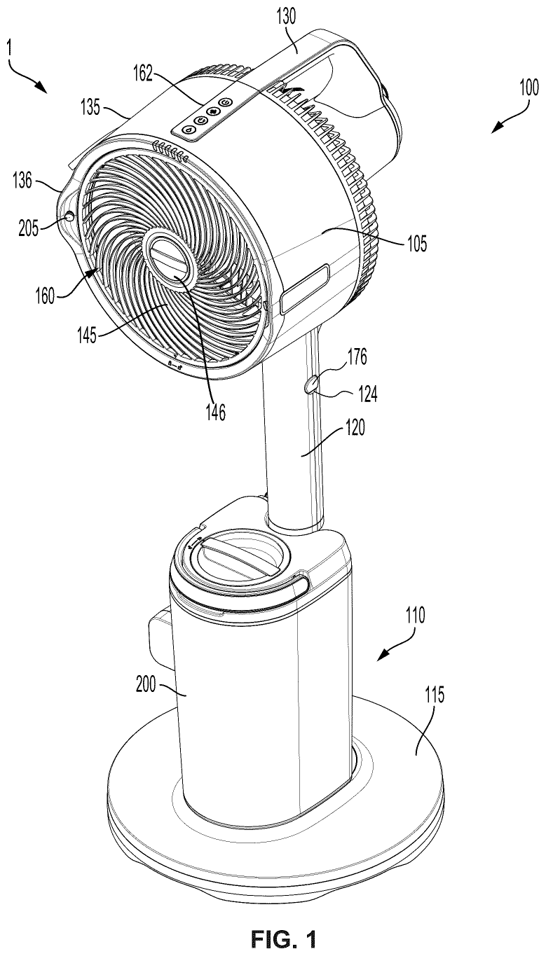

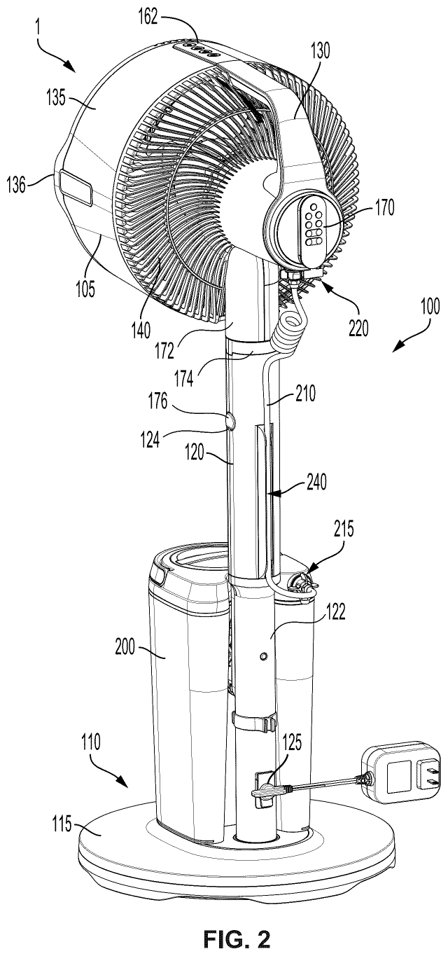

Referring to FIGS. 1-6, the present disclosure includes a misting fan 1 having a fan device 100 and a supply tank 200. In some embodiments, as shown for example in FIGS. 1-2, supply tank 200 directly couples to fan device 100. Supply tank 200 is configured to store a fluid, for example, water. Directly coupling supply tank 200 to fan device 100 can minimize the space occupied by misting fan 1 so users can install misting fan 1 in, for example, a bedroom, office, or workshop, without using extra space for supply tank 200. Accordingly, misting fan 1 provides users the added benefit and comfort of mist, without occupying more space than a fan of similar size that lacks misting features.

In some embodiments, fan device 100 has a fan device bounded volume and misting fan 1 includes a misting fan bounded volume. As used herein, bounded volume is a rectangular cuboid that encapsulates an object. In some embodiments, misting fan 1 includes a ratio of misting fan 1 bounded volume over fan device 100 bounded volume that is equal to 1. In some embodiments, misting fan 1 includes supply tank 200 coupled to fan device 100, such that supply tank protrudes from the bounded volume of fan device 100, without disturbing the spatial arrangement of a room, such as a bedroom, office, or workshop. For example, in some embodiments, the ratio of misting fan 1 bounded volume to fan device 100 bounded volume is less than or equal to 1.5. In other words, coupling supply tank 200 to fan device 100 does not increase the bounded volume of fan device 100 by more than 50%. In some embodiments, the ratio of misting fan 1 bounded volume to fan device 100 bounded volume is less than or equal to 1.4, 1.3, 1.2, or 1.1. In some embodiments, the ratio of misting fan 1 bounded volume to fan device 100 bounded volume is about 1. A ratio of misting fan 1 bounded volume to fan device 100 bounded volume that is closer to 1 can improve user experience by introducing mist without occupying more space than fan device 100 absent misting features.

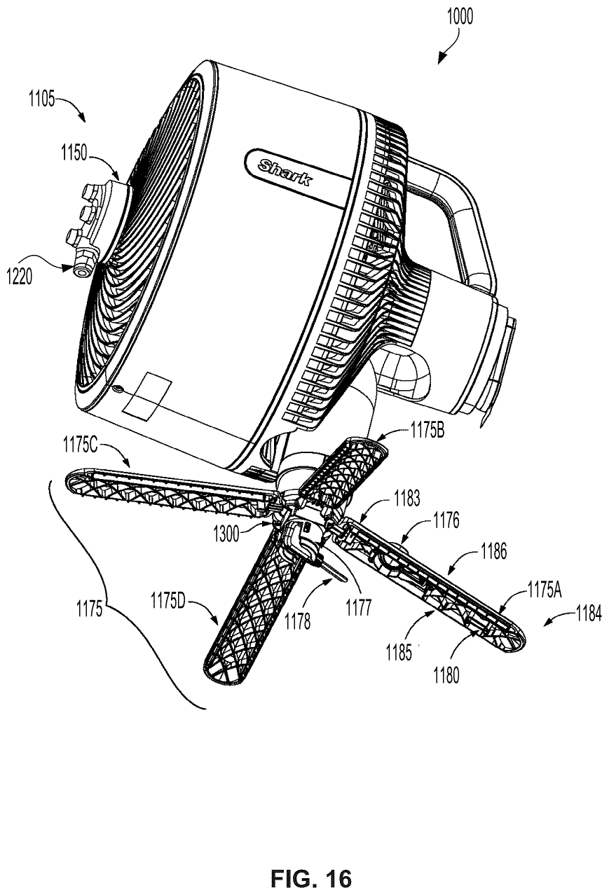

In some embodiments, fan device 100 has a head assembly 105 and a base assembly 110. In some embodiments, supply tank 200 is configured to couple to base assembly 110. As discussed in more detail below, in some embodiments head assembly 105 is detachably coupled to base assembly 110, and head assembly includes a plurality of legs 1175, as shown for example in FIGS. 14-16, so that head assembly 105 can stand on its own. In some embodiments, base assembly 110 includes a base 115, a housing 120, and a support 122 extending from base 115. In some embodiments, head assembly 105 is configured to couple to support 122. In some embodiments, supply tank 200 is configured to couple to base 115 and support 122.

In some embodiments, head assembly 105 includes a handle 130, a cylindrical front housing 135, a rear grill 140, and a front grill 145. In some embodiments, front grill 145 includes a hub 146 disposed on a central portion of front grill 145. In some embodiments, head assembly 105 includes a fan 160 arranged within housing 135.

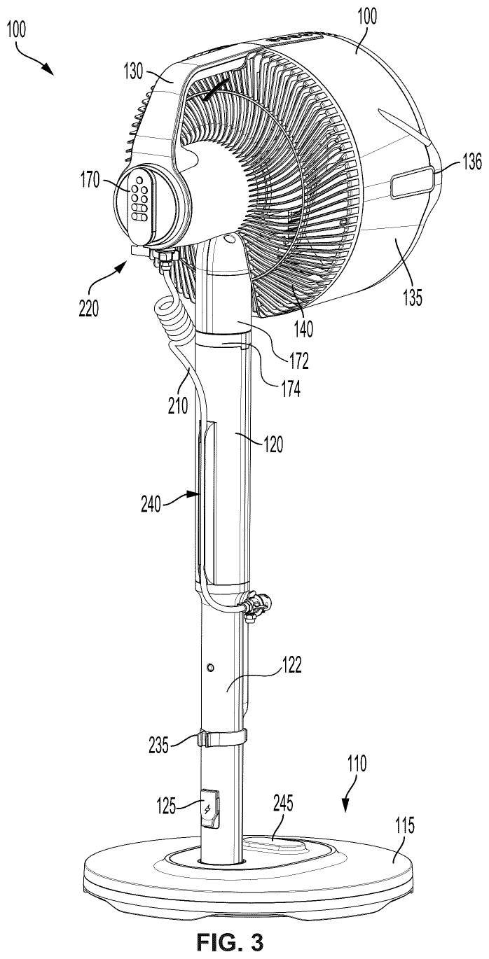

In some embodiments, as shown for example in FIGS. 2-3, head assembly 105 includes a port 220 configured to receive a first end of a hose 210, and supply tank 200 includes a port 215 configured to receive a second end of hose 210. In some embodiments, hose 210 is configured to guide liquid, such as water, from supply tank 200 to head assembly 105. In some embodiments, support 122 includes a passage 240 (e.g., a channel, tunnel, or groove) to guide and secure hose 210 against support 122.

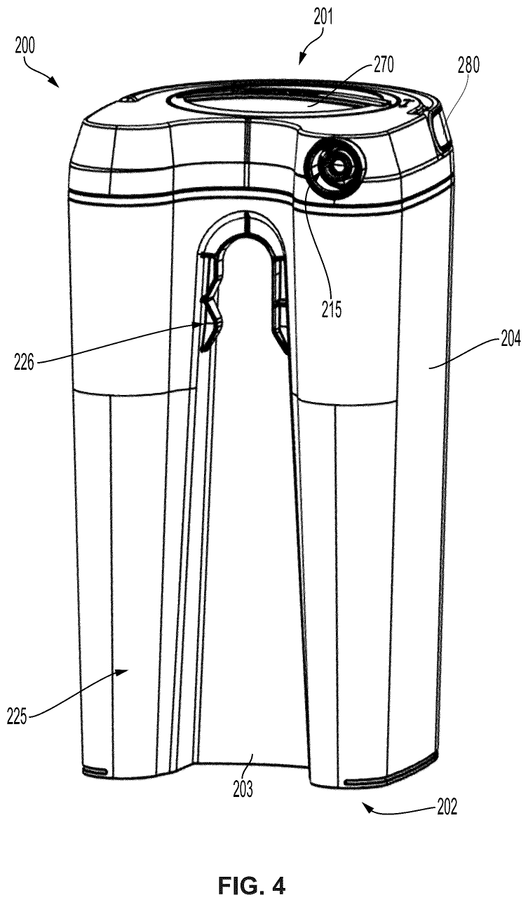

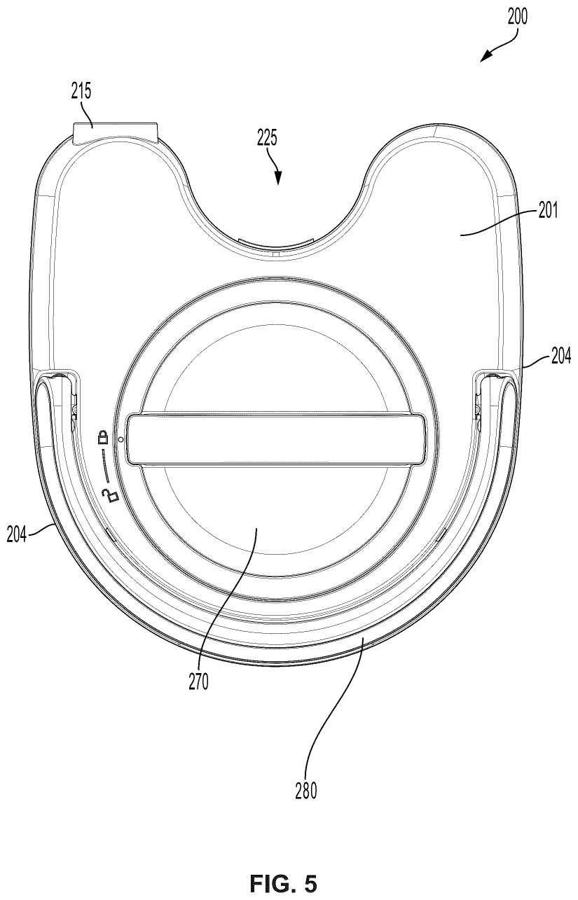

In some embodiments, as shown for example in FIGS. 4-5, supply tank 200 includes a top surface 201, a bottom surface 202, a rear surface 203, and side walls 204 connecting top surface 201, bottom surface 202, and rear surface 203. In some embodiments, supply tank 200 includes a removable lid 270 forming a portion of top surface 201. Removable lid 270 allows users to refill supply tank 200 and also prevents contaminants from entering supply tank 200. In some embodiments, removable lid 270 is configured to be locked and unlocked to supply tank 200. In some embodiments, removable lid 270 is configured to be rotated into and out of a locked position on supply tank 200. In some embodiments, removable lid 270 is configured to be pressed onto and pulled off from a locked position on supply tank 200. In some embodiments, as shown for example in FIGS. 4-5, supply tank 200 includes a handle 280 configured to pivot upward (e.g., away from top surface 201). Users can, for example, carry supply tank 200 by handle 280.

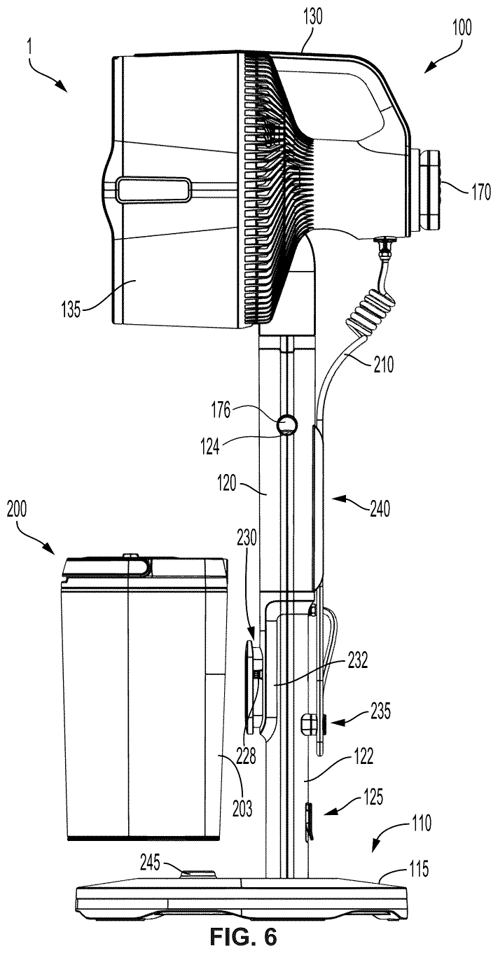

In some embodiments, as shown for example in FIG. 6, supply tank 200 is configured to be secured to support 122 and base 115. For example, in some embodiments, support 122 and base 115 include features to secure supply tank 200, such as one or more boss 245 on base 115 and/or one or more latches 230 on support 122.

For example, in some embodiments, as shown for example in FIGS. 4-5, rear surface 203 of supply tank 200 forms a receiving portion 225 including a socket 226. In some embodiments, receiving portion 225 is shaped to receive support 122. For example, in some embodiments, receiving portion 225 is a negative of support 122, or is generally channel shaped. In some embodiments, support 122 is completely disposed within receiving portion 225. In some embodiments, support 122 is at least partially disposed within receiving portion 225. In some embodiments, receiving portion 225 forms a flat or convex surface. Although a flat or convex rear surface 203 can bias supply tank 200 away from support 122 relative to a channel-shaped rear surface 203, which can increase misting fan 1 bounded volume, it can also facilitate securing supply tank 200 to fan device 100 with a simple supply tank 200 design that can be easy to manufacture. Ultimately, coupling supply tank 200 rear surface 203 to support 122 reduces the space occupied by misting fan 1, and the shape of receiving portion 225 shape can vary depending on the size of supply tank 200, manufacturing concerns, and other considerations.

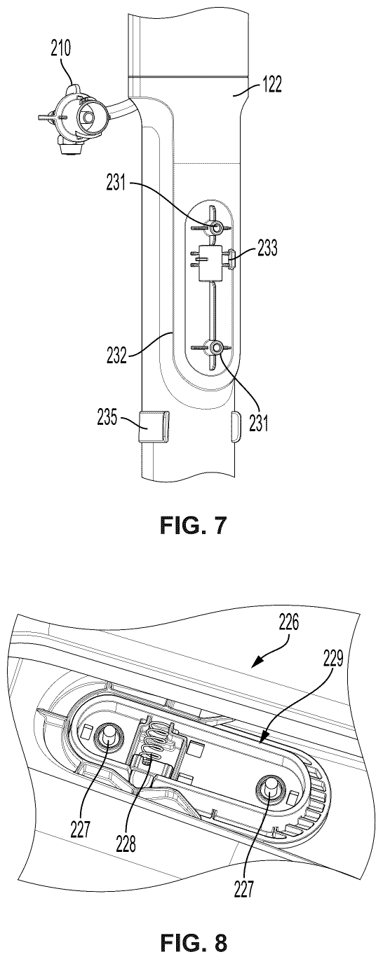

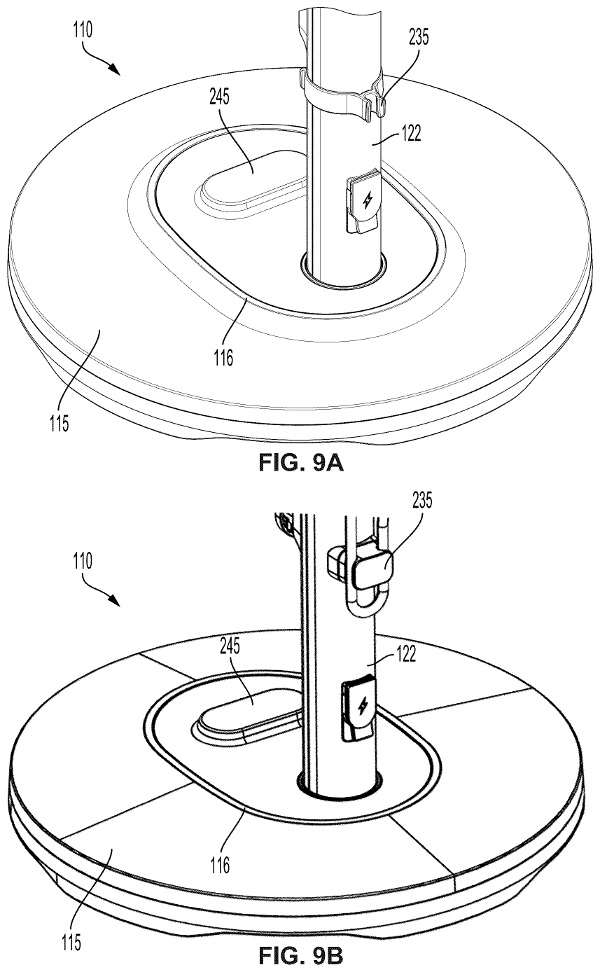

In some embodiments, as shown for example in FIGS. 7-8, supply tank 200 and support 122 include complementary features to secure supply tank 200 to support 122. Securing supply tank 200 to support 122 reduces the bounded volume of misting fan 1, so that, for example, misting fan 1 does not occupy more space than fan device 100 alone, despite including supply tank 200. Securing supply tank 200 to support 122 also mitigates the potential for supply tank 200 to separate from fan device 100. Further, securing supply tank 200 to a forward portion of support 122, as shown for example in FIGS. 1-2 and FIG. 6, positions the misting fan 1 center of gravity to mitigate the potential for misting fan 1 to fall forward during use that could damage head assembly 105.

In some embodiments, supply tank socket 226 is configured to couple to latch 230 on support 122. In some embodiments, latch 230 includes a raised platform 232 on support 122. In some embodiments, raised platform 232 provides clearance between supply tank 200 and support 122. The clearance introduced by raised platform 232 can, for example, mitigate vibrations in supply tank 200 that can produce undesirable noise, or can accommodate a sloped supply tank 200 rear surface 203 that reduces misting fan 1 bounded volume and/or positions the center of gravity of misting fan 1 to mitigate the potential for misting fan 1 to fall forward.

Further, in some embodiments, latch 230 includes an internal aperture 231 configured to receive a connecting pin 227 disposed in latch 230. In some embodiments, latch 230 includes a first internal aperture 231 configured to receive a first connecting pin 227 and a second internal aperture 231 configured to receive a second connecting pin 227. In some embodiments, the first and second aperture, and the corresponding first and second connecting pin are arranged vertically with respect to each other such that, as shown for example in FIGS. 7-8, the first aperture is above the second aperture, and the first connecting pin is above the second connecting pin. In other words, in some embodiments, as shown for example in FIG. 7, the first aperture and the second aperture are both disposed in latch 230 along an axis that is parallel to a longitudinal axis of support 122. In some embodiments, the first aperture and second aperture, and the corresponding first connecting pin and second connecting pin are disposed horizontally relative to each other. In other words, in some embodiments, the first aperture and the second aperture are both disposed in latch 230 along an axis that extends orthogonal to a longitudinal axis of support 122. Further, in some embodiments, latch 230 includes more than two internal apertures 231 and more than two corresponding connecting pins 227.

In some embodiments, latch 230 includes a tab 233 configured to engage biasing member 228 when socket 226 receives latch 230. In some embodiments, tab 233 engages biasing member 228 to secure supply tank 200 to support 122 and resist separation between supply tank 200 and support 122. For example, in some embodiments, when a user slides supply tank 200 downward onto latch 230, socket 226 presses biasing member 228 inward, and tab 233 retains biasing member 228 inside socket 226. As shown for example in FIG. 8, when supply tank 200 is secured to latch 230 biasing member 228 is inside socket 226.

In some embodiments, latch 230 includes a slot 229. In some embodiments, connecting pin 227 and/or a biasing member 228 are disposed within slot 229. In some embodiments, slot 229 is arcuate, rectangular, circular, oval, oblong, or any other shape configured receive a corresponding portion of latch 230. As discussed, securing supply tank 200 to support 122 reduces misting fan 1 bounded volume, and mitigates the potential for supply tank 200 to separate from fan device 100.

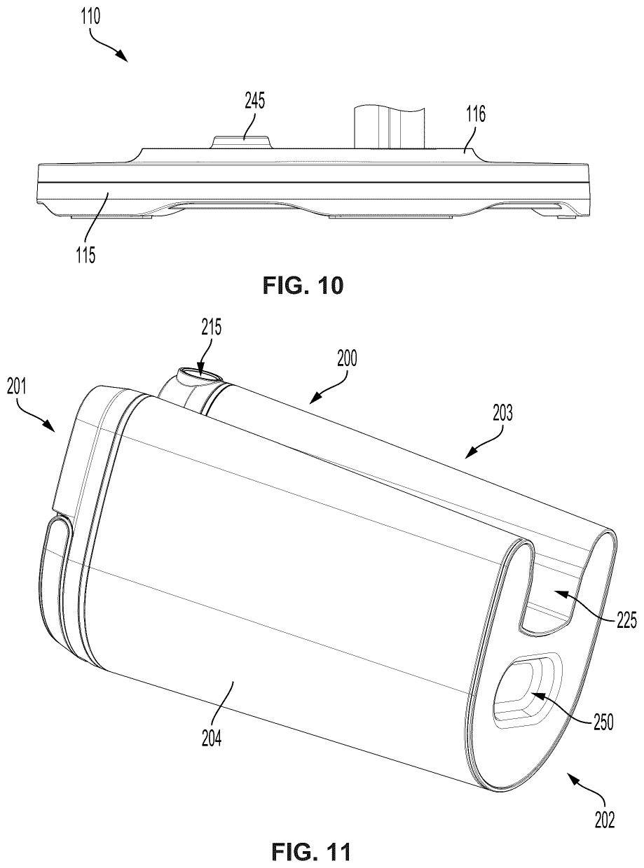

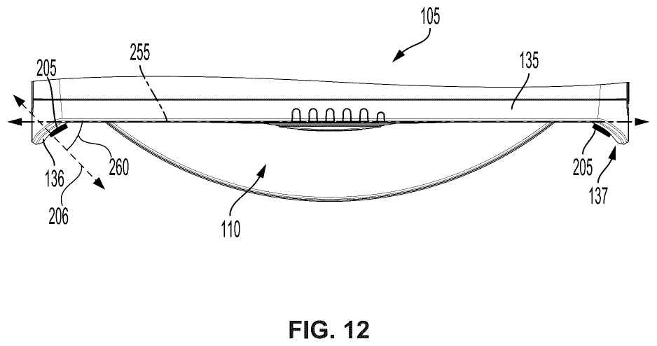

In some embodiments, as shown for example in FIGS. 9A-11, supply tank 200 and base 115 include complementary features such as protrusion(s) and/or recess(es) to secure supply tank 200 to base 115. For example, in some embodiments, base 115 includes a boss 245 extending from base 115. In some embodiments, boss 245 extends from a base platform 116 raised relative to base 115. Base platform 116 provides an increased thickness at a central portion of base 115, where, for example, supply tank 200 rests, to improve durability and stability. In some embodiments, as shown for example in FIGS. 9A-9B, misting fan 1 includes a clamp 235 coupled to support 122 and configured to secure hose 210. As shown for example in FIG. 9A, clamp 235 can include a prong configured to secure hose 210. In some embodiments, as shown for example in FIG. 9B, clamp 235 includes a plurality of channels configured to secure hose 210 at multiple points along hose 210. FIGS. 9A-9B illustrate non-limiting examples of clamp 235. Clamp 235 can be any structure configured to secure hose 210.

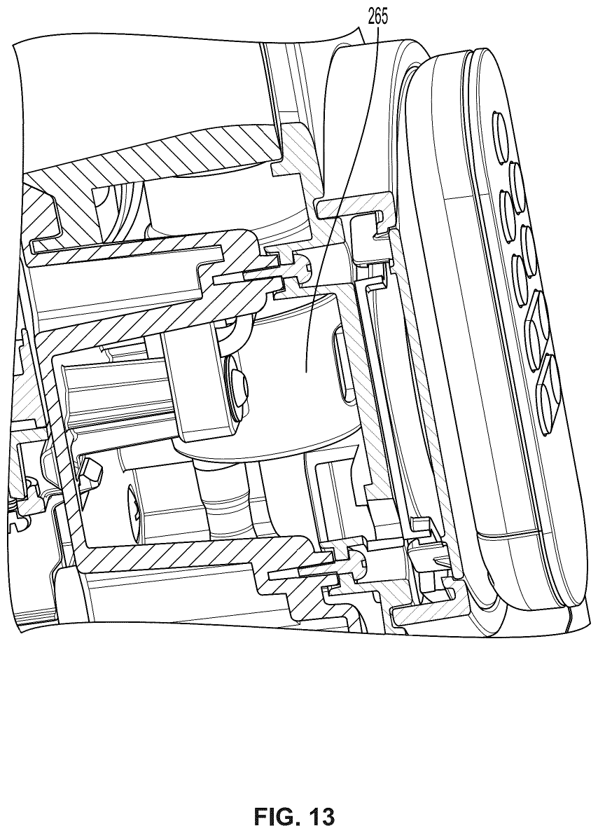

As shown for example in FIG. 11, in some embodiments supply tank 200 includes a bottom port 250 disposed in bottom surface 202. In some embodiments, bottom port 250 is configured to receive boss 245. In some embodiments, bottom port 250 is configured to receive boss 245 so bottom surface 202 is coincident with base platform 116. The connection between boss 245 and bottom port 250 secures supply tank 200 to base 115 and mitigates wobble and separation of supply tank 200 from fan device 100. In some embodiments, boss 245 is oval shaped, rectangular, circular, triangular, or any other shape suitable to be engage a corresponding negative shape forming bottom port 250. Further, in some embodiments, boss 245 has a uniform thickness. In some embodiments, boss 245 has variable thickness. In some embodiments, boss 245 has tapered edges.

In some embodiments, as shown for example in FIG. 6, supply tank 200 is configured to be secured to fan device 100 at support 122 and base 115. In some embodiments, supply tank 200 is configured to be secured to fan device 100 only at support 122. In some embodiments, supply tank 200 is configured to be secured to fan device 100 only at base 115. In some embodiments, supply tank 200 and fan device 100 have additional complementary features to secure supply tank 200 to fan device 100, such as, for example, a second boss extending from platform 116 and a corresponding second bottom port, and/or a second latch and a corresponding second socket. In some embodiments, misting fan 1 includes a fastener, such as a strap or cable, configured to secure supply tank 200 to fan device 100. Ultimately, supply tank 200 can be secured to fan device 100 in any manner suitable to reduce the likelihood that supply tank 200 separates from fan device 100 and/or to reduce vibrations during operation.

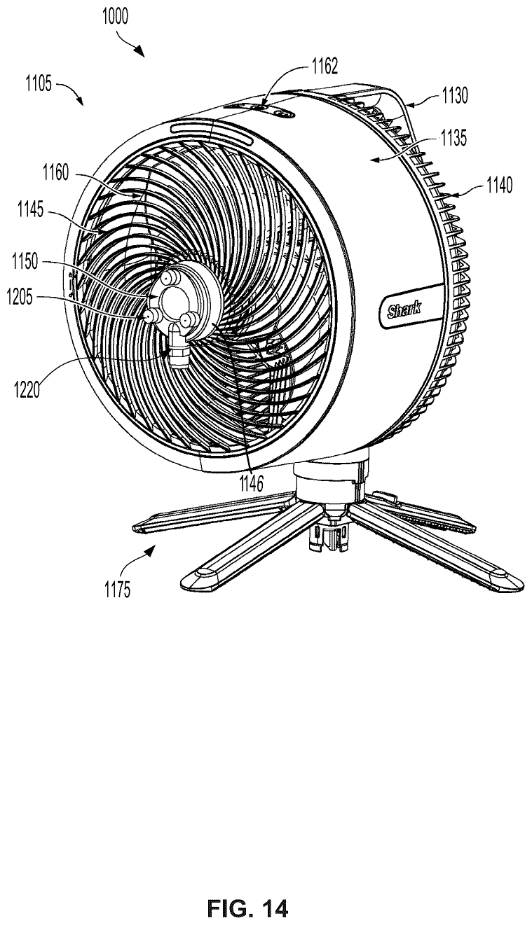

In some embodiments, as shown for example in FIG. 12, misting fan 1 includes a nozzle 205 disposed on head assembly 105. In some embodiments, a longitudinal axis 206 of nozzle 205 forms an angle 260 with a front plane 255 of head assembly 105. In some embodiments, the nozzle 205 longitudinal axis 206 forms an angle 260 outward from head assembly 105 that is at least 15 degrees. Orienting nozzle 205 at an angle 260 from head assembly 105 encourages mist to travel away from head assembly 105 and in the direction of air flow, as opposed to travelling into head assembly 105. In some embodiments, angle 260 between nozzle 205 longitudinal axis 206 and head assembly 105 front plane 255 is between 15 and 90 degrees. In some embodiments, angle 260 is between 15 and 30 degrees, between 30 and 45 degrees, between 45 and 60 degrees, between 60 and 75 degrees, or between 75 and 90 degrees. In some embodiments, misting fan 1 includes a first nozzle and a second nozzle disposed on opposite sides of head assembly and/or proximate front housing 135.

Positioning nozzles 205 on opposite sides of head assembly 105 and/or proximate front housing can provide more convenient access for internal tubing carrying fluid through hose 210 (e.g., from supply tank 200) to nozzles 205, such that, for example, persons assembling misting fan 1 can route internal tubing to nozzles 205 at areas of misting fan 1 that have sufficient space for a hand and/or tool. In some embodiments, as shown for example in FIG. 12, misting fan 1 includes a first nozzle and a second nozzle disposed on opposite sides of head assembly 105 from each other. In some embodiments, the first nozzle and second nozzle are disposed on opposite sides of hub 146. In some embodiments, as shown for example in FIG. 1, the first nozzle is disposed to the left of hub 146 and the second nozzle is disposed to the right of hub 146 when viewing misting fan 1 in a front view. In some embodiments, the first nozzle is disposed above hub 146 and the second nozzle is disposed below hub 146 when viewing misting fan 1 in a front view. In some embodiments, the first nozzle is disposed above hub 146 and to the left of hub 146, and the second nozzle is disposed below hub 146 and to the right of hub 146 when viewing misting fan 1 in a front view. In some embodiments, the first nozzle is disposed below hub 146 and to the left of hub 146, and the second nozzle is disposed above hub 146 and to the right of hub 146 when viewing misting fan 1 in a front view. Further, in some embodiments, misting fan 1 includes more than two nozzles.

In some embodiments, as shown for example in FIG. 12, nozzle 205 is disposed in recessed portion 137 of housing 135. In some embodiments, housing 135 includes an inflection 136 proximate recessed portion 137 that extends housing 135 in front of nozzles 205 at localized areas proximate nozzles 205. Inflection 136 protects nozzle 205 if, for example, misting fan 1 falls forward.

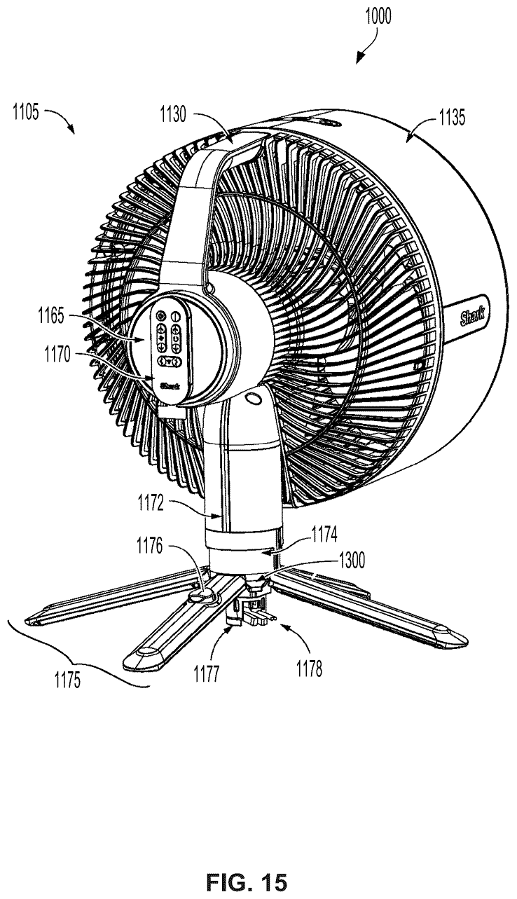

Further, in some embodiments, as shown for example in FIG. 13, a pump 265 is disposed inside head assembly 105. Pump 265 is configured to draw liquid from supply tank 200 (e.g., through hose 210 and internal tubing) into nozzles 205 in order to atomize the liquid and produce mist. For example, pump 265 can be any pump or suction device configured to produce a vacuum strong enough to draw liquid from supply tank 200 into nozzles 205.

Further, in some embodiments, misting fan 1 includes a plurality of nozzles disposed on hub 146. For example, in some embodiments, such as shown in FIG. 14, misting fan 1000 includes a misting unit 1150 disposed on hub 1146 that includes a plurality of nozzles 1205. In some embodiments, misting unit 1150 includes a single nozzle 1205. In some embodiments, misting unit 1150 is detachable from head assembly 1105.

Further, as previously discussed, in some embodiments, head assembly 105 is configured to detachably couple to base assembly 110. For example, in some embodiments, as shown in FIGS. 14-18, misting fan 1000 includes a head assembly 1105 that can be decoupled from base assembly 1110 and can operate as a free-standing unit separately from base assembly 1110. In some embodiments, supply tank 200 is configured to couple to head assembly 1105 via hose 210 connected to misting fan port 1220. In some embodiments, supply tank 200 can rest on, for example, a table or the floor. In some embodiments, supply tank 200 is configured to rest on a surface that is lower, or higher, than legs 1175.

Head assembly 1105 can have substantially similar features as head assembly 105, including nozzles 205 (e.g., nozzles 205 disposed proximate outer perimeter of head assembly 105 as shown for example in FIGS. 1-12 and/or disposed on hub 146 as shown for example in FIG. 14) and pump 265. Accordingly, FIGS. 14-22 reference substantially similar parts as previously disclosed, and include part number references that are incremented by 1000 relative to FIGS. 1-13. The following paragraphs refer to part numbers that are incremented by 1000 relative to FIGS. 1-13, unless noted otherwise (e.g., express references to FIGS. 1-13), but similar parts can be seen in FIGS. 1-13. The part number references are for readability.

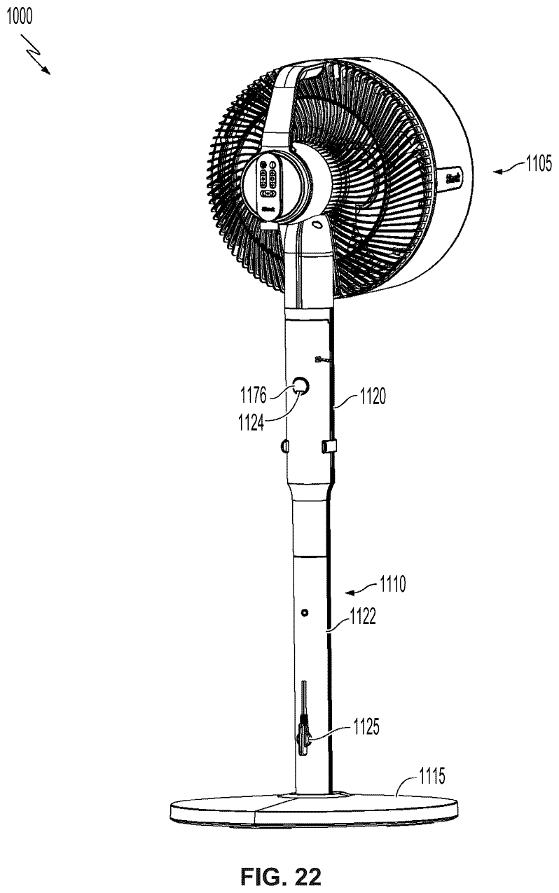

In some embodiments, head assembly 1105 includes 3, 4, 5, 6, or 7 legs 1175. In some embodiments, at least one leg 1175, such as leg 1175A, includes an attachment mechanism 1176 disposed on an exterior surface 1186 of leg 1175. In some embodiments, attachment mechanism 1176 includes a protrusion or button configured to be received within an opening 1124 of a housing 1120 configured to cover legs 1175 when the head assembly 1105 is coupled to the base assembly 1110, such as shown in FIG. 22. In some embodiments, attachment mechanism 1176 is coupled to an actuation mechanism 1179 configured to cause attachment mechanism 1176 to be movably provided through an opening in, for example, leg 1175A. In some embodiments, attachment mechanism 1176 is disposed on a side portion of housing 120. In some embodiments, as shown for example in FIG. 22, attachment mechanism 1176 is disposed on a rear portion of housing 1120.

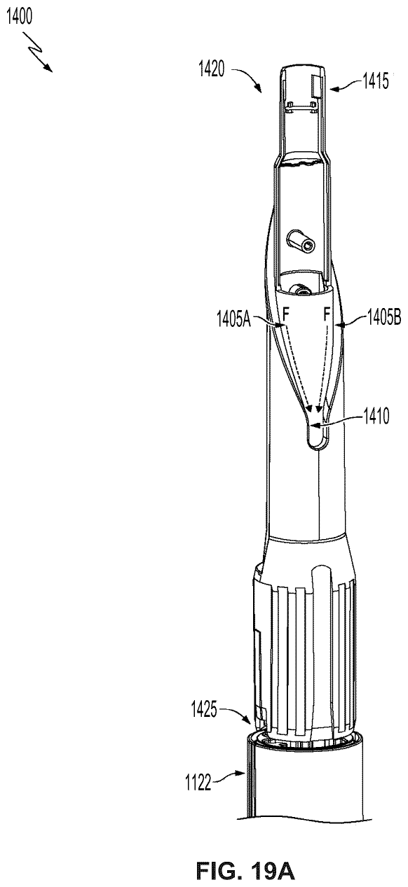

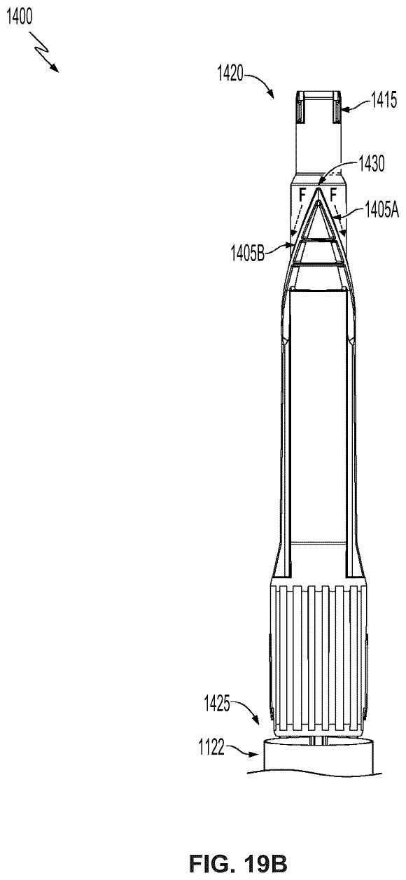

In some embodiments, articulation mechanism 1300 enables legs 1175 to translate together, in unison, when translating from a folded position, as shown in FIG. 18, when head assembly 1105 is coupled to base assembly 1110 or initially decoupled from the base assembly 1110, to an extended position, as shown in FIGS. 14-16, when head assembly 1105 has been decoupled from the base assembly 1110 and legs 1175 have been opened from their folded position. In some embodiments, articulation mechanism 1300 includes a plurality of interconnected gears 1305 as shown in FIG. 17. Gears 1305 can cause legs 1175 to articulate synchronously, such that, for example, leg 1175A is translated between a stowed and extended position (or vice versa), the remainder of legs 1175 articulate cooperatively in unison with the translated leg 1175A. In this way, extending legs 1175 between the folded and extended positions is easier relative to embodiments requiring articulating individual legs.

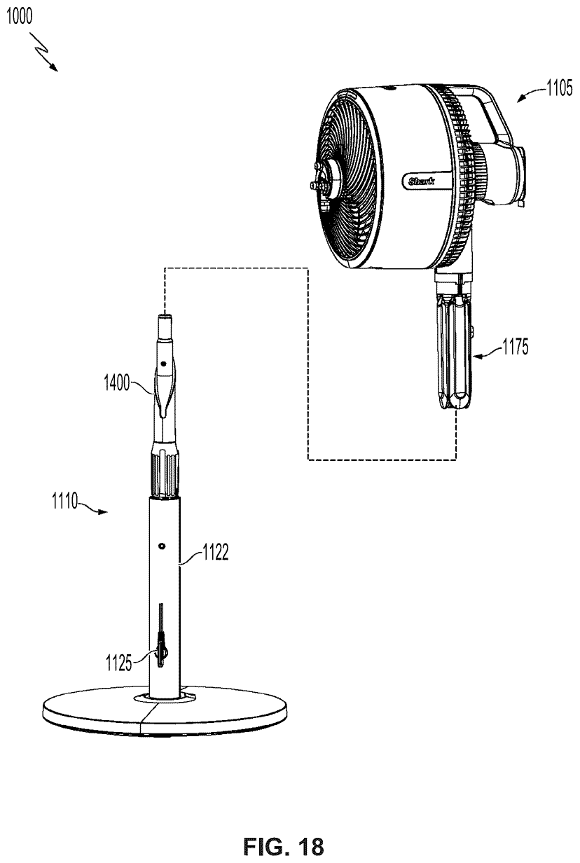

In some embodiments, gears 1305 of articulation mechanism 1300 are disposed at a first end of each leg 1175. In some embodiment, first end 1183 of each leg is adjacent to power supply housing 1177 and opposite to a second end 1184 as shown in FIG. 16. In some embodiments, first end 1183 of each leg 1175 can include a neck portion 1181 that can be integrally formed with a cylindrical cross-member 1182. In some embodiments, a gear 1305 is disposed at each end of cross-member 1182. For example, as shown in FIG. 17, in some embodiments, leg 1175A includes gears 1305A-1 and 1305A-2 at terminal ends of cross-member 1182A. In some embodiments, a second adjacent leg 1175B includes gears 1305B-1 and 1305B-2 arranged at terminal ends of its respective cross-member 1182B. Gear 1305A-2 of leg 1175A can engage with gear 1305B-1 of leg 1175B. Similarly, gear 1305B-2 of leg 1175B can engage with gear 1305C-1 of leg 1175C. In some embodiments, neck portions 1181, cross-members 1182, and gears 1305 are arranged within a frame 1310 as shown in FIG. 17. In some embodiments, frame 1310 houses first end 1183 of legs 1175 to enable gears 1305 of adjacent legs 1175 to fold or extend in unison.

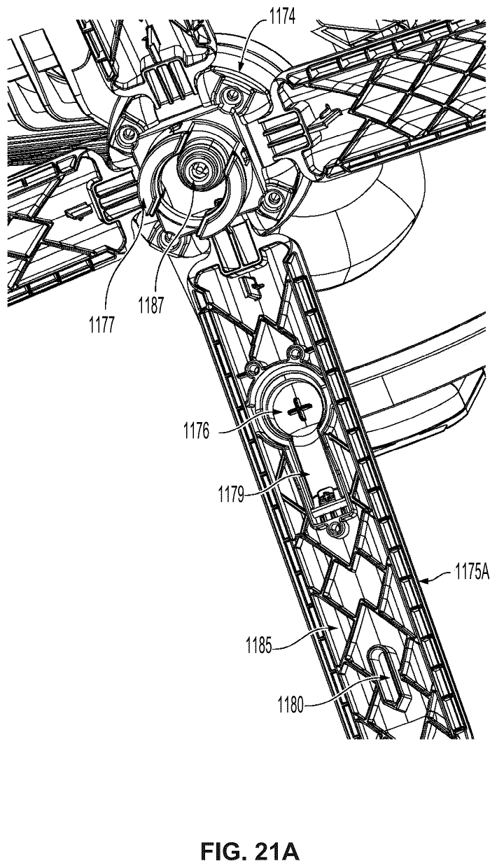

Returning to the base assembly 1110, as shown in FIG. 18, in some embodiments, a receiving portion 1400 can be coupled to support 1122 to facilitate coupling with head assembly 1105. In FIG. 18, housing 1120, shown in FIG. 22, has been removed for clarity. In some embodiments, receiving portion 1400 is an elongate member with a plurality of attachment features configured to couple with and secure head assembly 1105. In some embodiments, legs 1175 form a cavity therein along the length of legs 1175 when legs 1175 are arranged in the folded position as shown in FIG. 18. In some embodiment, head assembly 1105 is configured to couple to receiving portion 1400 such that legs 1175 can be positioned atop the receiving portion 1400 and can slide down onto the receiving portion 1400. In some embodiments, attachment features on legs 1175, such as protrusion 1180 shown for example in FIGS. 16 and 20, engage attachment features on receiving portion 1400 to allow head assembly 1105 to couple to base assembly 1110.

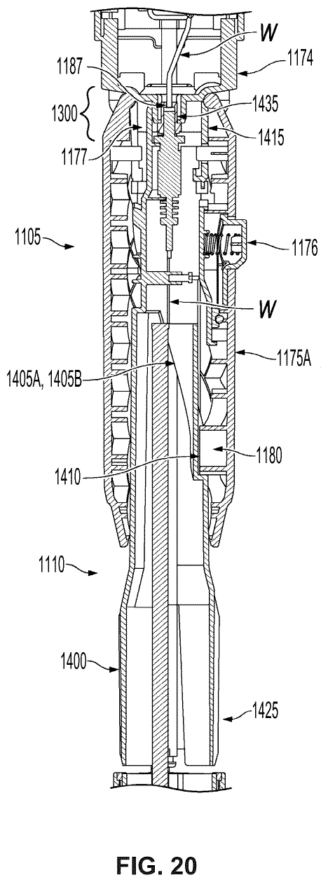

Example attachment features of receiving portion 1400 can be seen in FIGS. 19A-19B and FIG. 20. In some embodiments, receiving portion 1400 includes an elongate shape extending between a first end 1420 and a second end 1425. In some embodiments, a pair of opposing surfaces 1405 extend from first end 1420 of receiving portion 1400 toward second end 1425. In some embodiments, opposing surfaces 1405 have a substantially spiral-shape extending around the receiving portion 1400. In some embodiments, opposing surfaces 1405 extend from a first side of receiving portion 1400, as shown in FIG. 19B toward a notch 1410 on a second side of receiving portion 1400 shown in FIG. 19A. In some embodiments, opposing surfaces 1405 define a guide path F therebetween.

In some embodiments, protrusion 1180 is disposed on an interior surface 1185 of, for example, leg 1175A, as shown in FIG. 16, and is received between opposing surfaces 1405 and can be translated along guide path F into notch 1410 when head assembly 1105 is coupled to receiving portion 1400. In some embodiments, opposing surfaces 1405 extend from an apex 1430 adjacent to first end 1420 of receiving portion 1400. In some embodiments, apex 1430 encourages protrusion 1180 to translate in a first rotational direction along surface 1405A or a second rotational direction along surface 1405B. In this way, regardless of the orientation of the head assembly 1105 when initially coupled with the base assembly 1110 protrusion 1180 on at least one of legs 1175 can engage with either of the opposing surfaces 1405 and can be guided downward along the guide path F into a secure position within notch 1410 without requiring a user to manually secure the head assembly 1105 to base assembly 1110. In the cross-sectional view shown in FIG. 20 of head assembly 1105 coupled to base assembly 1110, protrusion 1180 of, for example, leg 1175A can be viewed within notch 1410 after having traveled along either of opposing surfaces 1405A or 1405B.

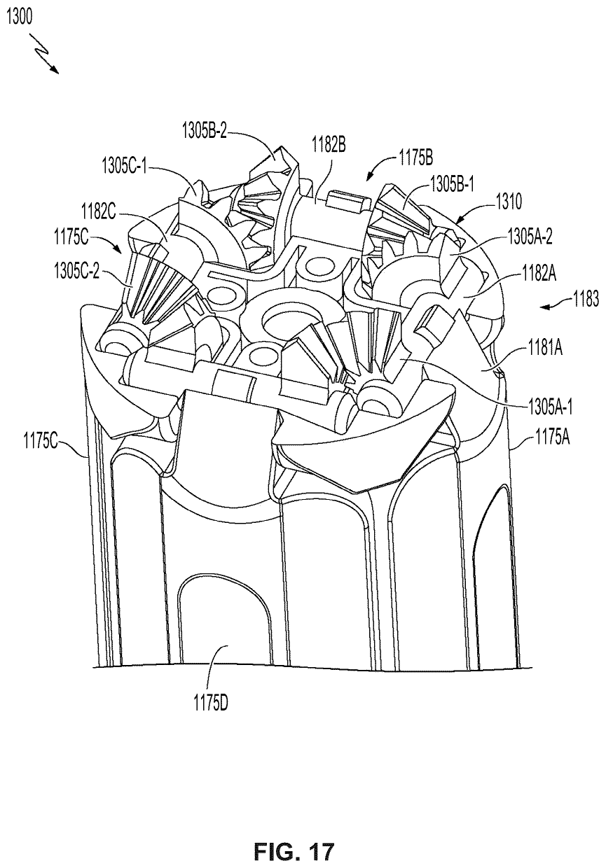

In some embodiments, a head assembly support 1172 couples rear housing 1165 to an oscillation unit 1174 configured to rotate head assembly 1105. In some embodiments, head assembly support 1172 couples rear housing 1165 to an oscillation unit 1174 configured to rotate head assembly 1105 relative to a plurality of legs 1175. In some embodiments, oscillation unit 1174 includes an oscillation motor 1152 as shown in FIG. 22. In some embodiments, oscillation unit 1174 is disposed in head assembly support 1172 and abuts an articulation mechanism 1300 to which the plurality of legs 1175 are coupled as shown in FIGS. 15-17.

In some embodiments, misting fan 1000 includes a user interface 1162 disposed on housing 1135 at, for example, an easily viewable location. In some embodiments, user interface 1162 includes a plurality of user input mechanisms, for example a button, slider, and/or touch-display, configured to receive user inputs and control operations. In some embodiments, the control operations include power and oscillation settings, scheduling, fan speed, and/or misting intensity. In some embodiments, misting fan 1000 includes a remote control unit 1170. In some embodiments, remote control unit 1170 is detachable from, for example, a rear housing 1165 protruding from a rear grill 1140. In some embodiments, remote control unit 1170 includes a plurality of user input mechanisms, such as a button, slider, and/or touch-display, configured to receive user inputs and control operations. In some embodiments, the control operations include power and oscillation settings, scheduling, fan speed, and/or misting intensity.

Further, in some embodiments, support 1122 includes a power supply 1125. In some embodiments, power supply 1125 can be a DC power supply and can include an electrical connector or jack. The DC power supply can be provided via a charging device configured to receive an AC power supply at a first side and generate the DC power supply at a second side, e.g., at the electrical connector of power supply 125. The charging device can include an electromagnetic compatibility (EMC) enclosure including a printed circuit board therein. The printed circuit board can include an AC/DC converter configured to generate DC power based on the received AC power. When, for example, head assembly 1105 is coupled to the base assembly 1110, head assembly 1105 can receive power via power supply 1125 provided in support 1122 of base assembly 1110.

In some embodiments, a power supply housing 1177 and a power supply 1178 are arranged beneath articulation mechanism 1300. In some embodiments, power supply 1178 is a DC power supply and includes an electrical connector or jack. The DC power supply can be provided via a charging device configured to receive an AC power supply at a first side and generate the DC power supply at a second side, e.g., at the electrical connector of power supply 1178. The charging device can include an electromagnetic compatibility (EMC) enclosure including a printed circuit board 1154 therein. In some embodiments, printed circuit board 1154B includes an AC/DC converter configured to generate DC power based on the received AC power. In some embodiments, when head assembly 1105 is decoupled from the base assembly 1110, head assembly 1105 receives power via power supply 1178 disposed in power supply housing 1177.

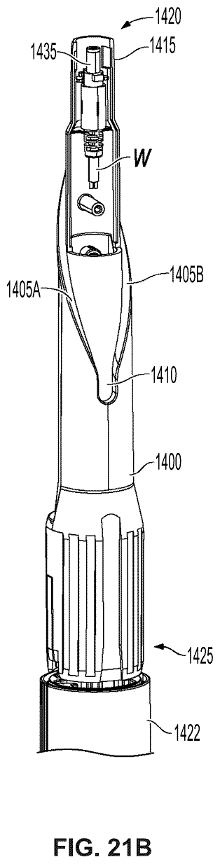

In some embodiments, head assembly 1105 is electrically coupled to base assembly 1110 by respective electrical connectors provided in head assembly 1105 and base assembly 1110. As shown for example in FIGS. 20 and 21A-21B, in some embodiments head assembly 1105 includes a first electrical connector 1187 provided within the power supply housing 1177. In some embodiments, first electrical connector 1187 is a male connector that can be received within a second electrical connector 1435 provided at a first end 1420 of receiving portion 1400. In some embodiments, second electrical connector 1435 is a female connector. In some embodiments, first electrical connector 1187 is a female connector and second electrical connector 1435 is a male connector. In some embodiments, when power supply housing 1415 of receiving portion 1400 engages power supply housing 1177 of head assembly 1105, first electrical connector 1187 can be received within second electrical connector 1435. In this way, head assembly 1105 can receive power via power supply 1125 disposed in support 1122 of base assembly 1110 when head assembly 1105 is received upon and coupled to receiving portion 1400 of base assembly 1110. In some embodiments, wiring W couples second electrical connector 1435 to power supply 1125.

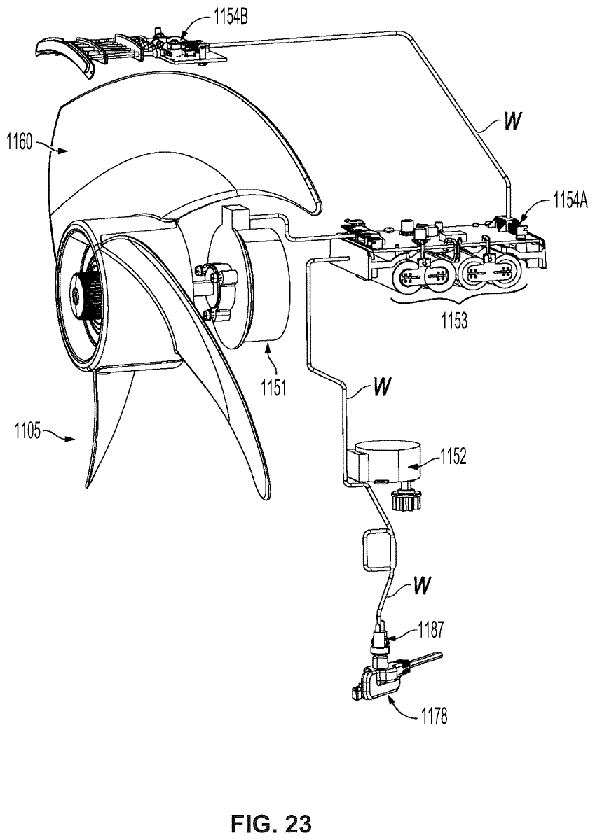

In some embodiments, head assembly 1105 receives power via first electrical connector 1187 when head assembly 1105 is decoupled from base assembly 1110. In some embodiments, as shown for example in FIG. 23, power supply 1178 is coupled to first electrical connector 1187 to provide power to components of head assembly 1105. For example, in some embodiments, wiring W receives power from first electrical connector 1187 and provides power to oscillation motor 1152, fan motor 1151, rechargeable batteries 1153, and other electrical components such as printed circuit boards 1154. In some embodiments, printed circuit board 1154A is configured to control operation of fan motor 1151 or oscillation motor 1152, as well as charging operations for rechargeable batteries 1153. In some embodiments, printed circuit board 1154B can be communicatively coupled to user interface 1162 and to printed circuit board 1154A to convey user inputs received via the user interface 1162 to printed circuit board 1154A. The provision of the rechargeable batteries 1153 enables head assembly 1105 to be operated in a stand-alone configuration that is separate from the base assembly 1110 and is not connected to the power supply 1178. Alternatively, power supply 1178 can be coupled to first electrical connector 1187 in the stand-alone configuration to charge batteries 1153 and provide power to the head assembly 1105.

It is to be appreciated that the Detailed Description section, and not the Summary and Abstract sections, is intended to be used to interpret the claims. The Summary and Abstract sections may set forth one or more but not all exemplary embodiments of the present disclosure as contemplated by the inventor(s), and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

What is claimed is:

1. A fan comprising:
a head assembly comprising a fan and a motor coupled to the fan, the head assembly comprising an articulation mechanism and a plurality of legs coupled to the articulation mechanism;
a base assembly detachably coupled to the head assembly, the base assembly comprising a base and a support having a first end coupled to the base and a second end opposite the first end, the support comprising a housing and an elongate receiving portion arranged within the housing at the second end of the support, the receiving portion configured to receive the plurality of legs to detachably couple the head assembly to the base assembly; and
a misting system comprising a supply tank, a pump, and a nozzle configured to atomize a liquid stored in the supply.

2. The fan of claim 1, wherein the nozzle is disposed within an outer perimeter of the head assembly.

3. The fan of claim 2, wherein the head assembly further comprises a housing, and the nozzle is disposed in a recessed portion of the housing.

4. The fan of claim 1, wherein the misting system further comprises a second nozzle spaced from the nozzle by about a diameter of the head assembly.

5. The fan of claim 1, further comprising a grill forming a forward portion of the head assembly, and a hub disposed at a central portion of the grill, wherein the nozzle is disposed on the hub.

6. The fan of claim 1, wherein the nozzle is disposed at an angle relative to a plane coplanar with a front of the head assembly.

7. The fan of claim 6, wherein the angle is between 15 and 75 degrees from the plane coplanar with the front of the head assembly.

8. The fan of claim 1, wherein the pump is disposed within the head assembly.

9. The fan of claim 1, wherein the supply tank is coupled to the base.

10. The fan of claim 9, wherein a bottom surface of the supply tank forms a port configured to receive a boss protruding from the base.

11. The fan of claim 1, wherein the supply tank is coupled to the support.

12. The fan of claim 11, wherein a rear surface of the supply tank forms a receiving portion configured to receive a latch on the support.

13. A misting fan comprising:
a fan device comprising a head assembly and a base assembly coupled to the head assembly, the base assembly comprising a base and a support;
a supply tank coupled to at least one of the support or the base; and
a pump configured to draw fluid from the supply tank to a nozzle disposed on the head assembly.

14. The misting fan of claim 13, wherein the supply tank comprises a port configured to receive a boss protruding upward from the base assembly.

15. The misting fan of claim 13, wherein a rear surface of the supply tank forms a receiving portion configured to receive at least a portion of the support.

16. The misting fan of claim 13, wherein the supply tank comprises a socket disposed in a rear surface of the supply tank, and configured to couple to a latch disposed on the support.

17. The misting fan of claim 16, wherein the latch comprises a biasing member configured to engage the socket.

18. The misting fan of claim 13, wherein the supply tank further comprises a supply tank port configured to attach to a first end of a hose, and the head assembly comprises a head assembly port configured to attach to a second end of the hose.

19. The misting fan of claim 13, wherein a ratio of a bounded volume of the misting fan to a bounded volume of the fan device is less than 1.5.

20. The misting fan of claim 20, wherein the ratio of the bounded volume of the misting fan to the bounded volume of the fan device is about 1.
